(19) United States
(12) Patent Application Publication
(10) Pub. No.: US 2023/0015475 A1
(43) Pub. Date: Jan. 19, 2023

(54) COMMUNICATION METHOD AND RELATED APPARATUS

(71) Applicant: HUAWEI TECHNOLOGIES CO., LTD., Shenzhen (CN)

(72) Inventors: Chunhua YOU, Shanghai (CN); Li ZHAO, Shenzhen (CN)

(73) Assignee: HUAWEI TECHNOLOGIES CO., LTD., Shenzhen, GD (CN)

(21) Appl. No.: 17/952,458

(22) Filed: Sep. 26, 2022

Related U.S. Application Data
(63) Continuation of application No. PCT/CN2021/083298, filed on Mar. 26, 2021.

(30) Foreign Application Priority Data
Mar. 28, 2020 (CN) 202010233004.X

(51) Int. Cl. H04W 24/08; H04W 74/08

(52) U.S. Cl. CPC H04W 24/08; H04W 74/0808

(57) ABSTRACT

A communication method and a related apparatus. The method includes: a terminal device receives first indication information sent by a network device. When the first indication information indicates a channel unoccupied time of the network device, within the channel unoccupied time, the terminal device skips performing downlink measurement, skips receiving the downlink data, skips sending a HARQ feedback corresponding to the downlink data, or determines that a downlink measurement result is invalid. Unnecessary measurement can be reduced, a downlink measurement failure caused because a network side does not preempt a channel can be excluded, and measurement efficiency and accuracy of a measurement result can be improved.

### CROSS-REFERENCE TO RELATED APPLICATIONS

This application is a continuation of International Application No. PCT/CN2021/083298, filed on Mar. 26, 2021, which claims priority to Chinese Patent Application No. 202010233004.X, filed on Mar. 28, 2020.The disclosures of the aforementioned applications are hereby incorporated by reference in their entireties.

### TECHNICAL FIELD

The embodiments relate to the field of communication technologies, a communication method and a related apparatus.

### BACKGROUND

Because an unlicensed spectrum is a shared spectrum resource, there are many different air interface technologies in the unlicensed spectrum. Therefore, to ensure coexistence of different air interface technologies in the unlicensed spectrum, a listen before talk (LBT) channel contention access mechanism is used to avoid mutual interference between the different air interface technologies. Because availability of a channel on the unlicensed spectrum cannot be ensured at any time, before data transmission, LBT requires to first monitor the channel, perform clear channel assessment (CCA), and then transmit data when ensuring that the channel is idle. CCA refers to determining, by detecting a signal strength on an unlicensed spectrum resource, whether the channel is idle.

Currently, LBT can be classified into omnidirectional-based LBT and direction-based LBT. The omnidirectional-based LBT means that a device receives signals in all directions, and then measures the signals to obtain signal strengths. If the signal strength is greater than a preset threshold, it indicates that a channel is idle. Alternatively, if the signal strength is less than or equal to a preset threshold, it indicates that a channel is busy. The direction-based LBT means that a device receives signals only in some directions, and then measures the signals in some directions to obtain signal strengths in some directions. If the signal strength in some directions is greater than a preset threshold, it indicates that a channel is idle in some directions. Alternatively, if the signal strength in some directions is less than or equal to a preset threshold, it indicates that a channel is busy in some directions. When the channel is idle, the device may obtain a channel occupancy time (COT) of the channel, and may indicate the COT in a broadcast form, so that another device does not perform channel access on the channel within the COT after receiving an indication. However, currently, an indication of the channel occupancy time is applicable only to the omnidirectional-based LBT and is not applicable to the direction-based LBT.

### SUMMARY

The embodiments may provide a communication method and a related apparatus, to provide direction-based channel occupancy indication information. When the indication information indicates that a channel is occupied, downlink measurement is not performed, and when the indication information indicates that the channel is not occupied, downlink measurement is performed. Therefore, unnecessary measurement can be reduced, a downlink measurement failure caused because a network side does not preempt the channel can be excluded, and measurement efficiency and accuracy of a measurement result can be improved.

The following describes different aspects of the embodiments. It should be understood that mutual reference may be made to the following implementations and beneficial effects of the different aspects.

According to a first aspect, an embodiment may provide a communication method. The method is applicable to a terminal device, and the method includes: The terminal device receives first indication information sent by a network device. The first indication information indicates channel occupancy information of the network device, and the channel occupancy information includes a channel occupancy time and/or a channel unoccupied time. When the first indication information indicates the channel occupancy time of the network device, if the network device configures a corresponding downlink resource (for example, a downlink transmit beam or a serving cell) for the terminal device, the terminal device performs downlink measurement and/or receives downlink data within the channel occupancy time. When the first indication information indicates the channel unoccupied time of the network device, within the channel unoccupied time, the terminal device skips performing downlink measurement, skips receiving the downlink data, skips sending a HARQ feedback corresponding to the downlink data, or determines that a downlink measurement result is invalid.

Optionally, the first indication information may include at least one beam identity and channel occupancy information corresponding to each of the at least one beam identity. The beam identity included in the first indication information may be used to notify the terminal device of a beam corresponding to the channel occupancy information of the network device. The channel occupancy information corresponding to the beam identity included in the first indication information may be used to notify the terminal device of an LBT result of the network device. The channel occupancy time may include a channel occupancy start time and channel occupancy duration. The channel unoccupied time may include unoccupied duration of the channel

Optionally, the first indication information may alternatively include a cell identity and the channel occupancy information.

In this embodiment, only when a network side preempts a channel and the network side configures the corresponding downlink resource for the terminal device, the terminal device performs downlink measurement and/or receives the downlink data within the channel occupancy time indicated by the first indication information. When the network side does not preempt the channel, even if the network side configures the corresponding downlink resource for the terminal device, within the channel unoccupied time indicated by the first indication information, the terminal device does not need to perform downlink measurement, does not receive the downlink data, does not send the HARQ feedback corresponding to the downlink data, or determines that the downlink measurement result is invalid. Therefore, unnecessary measurement is reduced, a downlink measurement failure caused because the network side does not preempt the channel is excluded, and measurement efficiency and accuracy of a measurement result are improved.

With reference to the first aspect, in a possible implementation, the first indication information includes the at least one beam identity and a channel occupancy time corresponding to each of the at least one beam identity. That the terminal device performs downlink measurement and/or receives downlink data within the channel occupancy time includes: If the beam identity included in the first indication information includes a beam identity of a first beam included in the downlink resource configured by the network device for the terminal device, the terminal device performs downlink measurement on the first beam, and/or receives downlink semi-persistent scheduling DL SPS from the first beam within a channel occupancy time of the first beam. After an SPS resource is activated, the terminal device may receive and send data by using the activated SPS resource. Therefore, the terminal device receives the DL SPS from the first beam, in other words, receives the downlink data from the first beam.

Optionally, the first indication information includes the at least one beam identity and a channel unoccupied time corresponding to each of the at least one beam identity. That, within the channel unoccupied time, the terminal device skips performing downlink measurement, skips receiving the downlink data, skips sending a HARQ feedback corresponding to the downlink data, or determines that a downlink measurement result is invalid includes: If the beam identity included in the first indication information includes the beam identity of the first beam included in the downlink resource configured by the network device for the terminal device, within a channel unoccupied time of the first beam, the terminal device skips performing downlink measurement on the first beam, skips receiving the downlink data from the first beam, skips sending the HARQ feedback corresponding to the downlink data, or determines that a downlink measurement result of the first beam is invalid.

In this embodiment, when the first indication information includes the channel occupancy time of the first beam, and the network device configures the corresponding downlink resource for the terminal device (where the first beam is the downlink transmit beam in the downlink resource configured by the network device for the terminal device), the terminal device performs downlink measurement on the first beam, and/or receives the downlink data from the first beam within the channel occupancy time of the first beam. Direction-based channel occupancy indication information (that is, the first indication information) is provided. Therefore, unnecessary measurement can be reduced, and measurement efficiency and accuracy of a measurement result can be improved.

With reference to the first aspect, in a possible implementation, the first indication information may further include an identifier of a TRP to which each beam identified by the at least one beam identity belongs and/or an identifier of a serving cell covered by the beam. The identifier of the TRP included in the first indication information is used to notify the terminal device of a TRP corresponding to the channel occupancy information of the network device. The identifier of the serving cell included in the first indication information is used to notify the terminal device of a cell corresponding to the channel occupancy information of the network device. One cell may be covered by a plurality of beams in different directions. One cell may include a plurality of TRPs, and one TRP may have a plurality of beams.

The first indication information in this embodiment not only includes the beam identity and the channel occupancy information, but may also include the identifier of the TRP and/or the identifier of the serving cell, so that the terminal device can more accurately locate a beam on a TRP and/or a beam in a serving cell occupied or not occupied by the channel. When the beam identity is multiplexed, a beam occupied by the channel or a beam not occupied by the channel can also be accurately located, thereby improving accuracy of subsequent downlink measurement, and ensuring subsequent reception of the downlink data.

With reference to the first aspect, in a possible implementation, the first indication information includes the cell identity and the channel occupancy time. That the terminal device performs downlink measurement and/or receives downlink data within the channel occupancy time includes: If the cell identity included in the first indication information is an identifier of a serving cell included in the downlink resource configured by the network device for the terminal device, within the channel occupancy time, the terminal device receives the DL SPS from the serving cell identified by the cell identity and/or performs downlink measurement on the serving cell.

With reference to the first aspect, in a possible implementation, the first indication information includes the cell identity and the channel unoccupied time. That, within the channel unoccupied time, the terminal device skips performing downlink measurement, skips receiving the downlink data, skips sending a HARQ feedback corresponding to the downlink data, or determines that a downlink measurement result is invalid includes: If the cell identity included in the first indication information is the identifier of the serving cell included in the downlink resource configured by the network device for the terminal device, within the channel unoccupied time, the terminal device skips receiving the DL SPS from the serving cell identified by the cell identity, skips sending a HARQ feedback corresponding to the DL SPS, skips performing downlink measurement on the serving cell, or determines that a downlink measurement result of the serving cell is invalid.

In this embodiment, when the first indication information indicates the channel unoccupied time, even if the network device configures the corresponding downlink resource for the terminal device (the cell identity included in the first indication information may be the identifier of the serving cell of the terminal device included in the downlink resource), within the channel unoccupied time, the terminal device skips receiving the downlink data from the serving cell identified by the cell identity, skips sending the HARQ feedback corresponding to the downlink data, skips performing downlink measurement on the serving cell, or determines that the downlink measurement result of the serving cell is invalid. Omnidirectional-based channel occupancy indication information is provided, to reduce unnecessary measurement, and reduce energy consumption of the terminal device.

With reference to the first aspect, in a possible implementation, the first indication information may be carried on a GC-PDCCH for sending.

With reference to the first aspect, in a possible implementation, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

According to a second aspect, an embodiment may provide another communication method. The method is applicable to a network device, and the method includes: The network device performs LBT to obtain an LBT result; and sends first indication information to a terminal device. The first indication information indicates channel occupancy information of the network device. The channel occupancy information includes a channel occupancy time and/or a channel unoccupied time. When the first indication information indicates the channel occupancy time of the network device, the first indication information indicates the terminal device to perform downlink measurement and/or receive downlink data within the channel occupancy time. When the first indication information indicates the channel unoccupied time of the network device, the first indication information indicates, within the channel unoccupied time, the terminal device to skip performing downlink measurement, skip receiving the downlink data, skip sending a HARQ feedback corresponding to the downlink data, or determine that a downlink measurement result is invalid.

Optionally, the first indication information may include at least one beam identity and channel occupancy information corresponding to each of the at least one beam identity. The beam identity included in the first indication information may be used to notify the terminal device of a beam corresponding to the channel occupancy information of the network device. The channel occupancy information corresponding to the beam identity included in the first indication information may be used to notify the terminal device of an LBT result of the network device. The channel occupancy time may include a channel occupancy start time and channel occupancy duration. The channel unoccupied time may include unoccupied duration of the channel

Optionally, the first indication information may alternatively include a cell identity and the channel occupancy information.

With reference to the second aspect, in a possible implementation, the first indication information includes the at least one beam identity and a channel occupancy time corresponding to each of the at least one beam identity. When the first indication information indicates the channel occupancy time of the network device, the first indication information may indicate, when the beam identity included in the first indication information includes a beam identity of a first beam included in a downlink resource configured by the network device for the terminal device, the terminal device to perform downlink measurement on the first beam, and/or receive DL SPS from the first beam within a channel occupancy time of the first beam.

Optionally, the first indication information includes the at least one beam identity and a channel unoccupied time corresponding to each of the at least one beam identity. When the first indication information indicates the channel unoccupied time of the network device, the first indication information may further indicate, when the beam identity included in the first indication information includes the beam identity of the first beam included in the downlink resource configured by the network device for the terminal device, within a channel unoccupied time of the first beam, the terminal device to skip performing downlink measurement on the first beam, skip receiving the downlink data from the first beam, skip sending the HARQ feedback corresponding to the downlink data, or determine that a downlink measurement result of the first beam is invalid.

With reference to the second aspect, in a possible implementation, the first indication information may further include an identifier of a TRP to which each beam identified by the at least one beam identity belongs and/or an identifier of a serving cell covered by the beam. The identifier of the TRP included in the first indication information is used to notify the terminal device of a TRP corresponding to the channel occupancy information of the network device. The identifier of the serving cell included in the first indication information is used to notify the terminal device of a cell corresponding to the channel occupancy information of the network device. One cell may be covered by a plurality of beams in different directions. One cell may include a plurality of TRPs, and one TRP may have a plurality of beams.

With reference to the second aspect, in a possible implementation, the first indication information includes the cell identity and the channel occupancy time. When the first indication information indicates the channel occupancy time of the network device, the first indication information may indicate, when the cell identity included in the first indication information is an identifier of a serving cell included in the downlink resource configured by the network device for the terminal device, within the channel occupancy time, the terminal device to receive the DL SPS from the serving cell identified by the cell identity or perform downlink measurement on the serving cell.

With reference to the second aspect, in a possible implementation, the first indication information includes the cell identity and the channel unoccupied time. When the first indication information indicates the channel unoccupied time of the network device, the first indication information may further indicate, when the cell identity included in the first indication information is the identifier of the serving cell included in the downlink resource configured by the network device for the terminal device, within the channel unoccupied time, the terminal device to skip receiving the DL SPS from the serving cell identified by the cell identity, skip sending a HARQ feedback corresponding to the DL SPS, skip performing downlink measurement on the serving cell, or determine that a downlink measurement result of the serving cell is invalid.

With reference to the second aspect, in a possible implementation, the first indication information may be carried on a GC-PDCCH for sending.

With reference to the second aspect, in a possible implementation, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

According to a third aspect, an embodiment may provide a terminal device. The terminal device includes a unit and/or a module configured to perform the communication method according to any one of the first aspect and/or the possible implementations of the first aspect. Therefore, beneficial effects (or advantages) of the communication method provided in the first aspect can also be achieved.

According to a fourth aspect, an embodiment may provide a network device. The network device includes a unit and/or a module configured to perform the communication method according to any one of the second aspect and/or the possible implementations of the second aspect. Therefore, beneficial effects (or advantages) of the communication method provided in the second aspect can also be achieved.

According to a fifth aspect, an embodiment may provide another terminal device. The terminal device may include a processor, a transceiver, and a memory. The memory is configured to store a computer program. The transceiver is configured to receive and send various information and/or data. The computer program includes program instructions. When the processor runs the program instructions, the terminal device is enabled to perform the communication method according to any one of the first aspect or the possible implementations of the first aspect. The transceiver may be a radio frequency module in the terminal device, a combination of the radio frequency module and an antenna, or an input/output interface of a chip or a circuit.

According to a sixth aspect, an embodiment may provide another network device. The network device may include a processor, a transceiver, and a memory. The memory is configured to store a computer program. The transceiver is configured to receive and send various information and/or data. The computer program includes program instructions. When the processor runs the program instructions, the network device is enabled to perform the communication method according to any one of the second aspect or the possible implementations of the second aspect. The transceiver may be a radio frequency module in the network device, a combination of the radio frequency module and an antenna, or an input/output interface of a chip or a circuit.

According to a seventh aspect, an embodiment may provide a communication system, including a terminal device and a network device. The terminal device is the terminal device described in the third aspect or the fifth aspect, and the network device is the network device described in the fourth aspect or the sixth aspect.

According to an eighth aspect, an embodiment may provide a non-transitory computer-readable storage medium. The non-transitory computer-readable storage medium stores computer program instructions. When the computer program instructions are run on a computer, the computer is enabled to perform the communication method described according to any one of the first aspect or the possible implementations of the first aspect.

According to a ninth aspect, an embodiment may provide another non-transitory computer-readable storage medium. The non-transitory computer-readable storage medium stores computer program instructions. When the computer program instructions are run on a computer, the computer is enabled to perform the communication method described according to any one of the second aspect or the possible implementations of the second aspect.

According to a tenth aspect, an embodiment may provide a program product including instructions. When the program product runs, the communication method described according to any one of the first aspect or the possible implementations of the first aspect is performed.

According to an eleventh aspect, an embodiment may provide a program product including instructions. When the program product runs, the communication method described according to any one of the second aspect or the possible implementations of the second aspect is performed.

According to a twelfth aspect, an embodiment may provide a chip, including a processor. The processor is configured to read and execute the program stored in the memory, to perform the communication method according to one or more of the first aspect or the second aspect, or one or more of all the possible implementations of the first aspect or the second aspect. Optionally, the chip further includes the memory, and the memory is connected to the processor by using a circuit. Further, optionally, the chip includes a communication interface, and the processor is connected to the communication interface. The communication interface is configured to receive data and/or information that need/needs to be processed. The processor obtains the data and/or the information from the communication interface, processes the data and/or the information, and outputs a processing result through the communication interface. The communication interface may be an input/output interface.

Optionally, the processor and the memory may be physically independent units, or the memory may be integrated with the processor.

According to an aspect, during implementation of the embodiments, direction-based channel occupancy indication information may be provided. According to another aspect, during implementation of the embodiments, when the indication information indicates that a channel is occupied, downlink measurement may not be performed, and when the indication information indicates that the channel is not occupied, downlink measurement may be performed. Therefore, unnecessary measurement is reduced, a downlink measurement failure caused because a network side does not preempt the channel is excluded, and measurement efficiency and accuracy of a measurement result are improved.

### BRIEF DESCRIPTION OF THE DRAWINGS

FIG. 1A is a schematic diagram of a system architecture of a mobile communication system according to an embodiment;

FIG. 1B is a schematic diagram of a 5G network architecture according to an embodiment;

FIG. 2 is a schematic flowchart of a communication method according to an embodiment;

FIG. 3 is a schematic diagram of an idle beam on a network side according to an embodiment;

FIG. 4 is another schematic flowchart of a communication method according to an embodiment;

FIG. 5 is a schematic diagram of a structure of a terminal device according to an embodiment;

FIG. 6 is a schematic diagram of a structure of a network device according to an embodiment; and

FIG. 7 is a schematic diagram of a structure of a communication apparatus according to an embodiment.

### DETAILED DESCRIPTION OF THE EMBODIMENTS

The following describes the embodiments with reference to the accompanying drawings.

To facilitate understanding a communication method provided in the embodiments, the following briefly describes some terms (nouns) in the communication method provided in the embodiments.

1. Listen Before Talk (LBT)

An LBT technology is also referred to as carrier sense multiple access (CSMA) and means that a transmission site first monitors a channel to determine whether another site transmits data. If the channel is idle, the transmission site may transmit the data; otherwise, the transmission site avoids the channel for a period of time and then attempts to transmit the data. The LBT mentioned in the embodiments may be direction-based LBT. The transmission site may monitor whether another site transmits the data on the channel in different directions (or beams). If detecting that another site transmits the data on the channel in a direction, the transmission site considers that the channel is busy in the direction. If detecting that no other site transmits data on the channel in a direction, the transmission site considers that the channel is idle in the direction. If the channel is idle in a direction, the transmission site may transmit data in the direction.

2. Channel State Information (CSI)

In the field of wireless communication, the CSI is a channel attribute of a communication link. The CSI describes a fading factor of a signal on each transmission path, that is, a value of each element in a channel gain matrix H, for example, information such as signal scattering, environment fading, distance attenuation, and the like. The CSI may enable a communication system to adapt to a current channel condition, to provide assurance for high-reliability and high-rate communication in a multi-antenna system. Generally, a receive end receives a reference signal, estimates the CSI based on the reference signal, quantizes the CSI, and feeds back the quantized CSI to a transmit end.

3. Physical Downlink Control Channel (PDCCH)

The PDCCH is a set of physical resource elements and carries uplink and downlink control information. According to different scopes of the PDCCH, the information carried in the PDCCH is classified into common control information (common search space) and dedicated control information (dedicated search space). Search space defines a start location and a channel search manner of blind detection. The PDCCH carries channel control information (including control information such as resource allocation, a frequency hopping type, and a transmission mode), that is, downlink control information (DCI), of a physical uplink shared channel (PUSCH) and a physical downlink shared channel (PDSCH). The DCI includes resource allocation and other control information of one or more terminals. PDCCH information of different terminals is distinguished by using radio network temporary identifier (RNTI) information corresponding to the terminals. A cyclic redundancy check (CRC) of DCI of the terminals may be scrambled by using RNTIs corresponding to the terminals.

4. Reference Signal Received Power (RSRP)

The RSRP is an average value of signal powers received on all resource elements (REs) that carry reference signals in a symbol. A beam RSRP means an RSRP on a beam.

5. Beam Failure Detection

A beam failure means that quality of a serving beam is lower than a threshold. Beam failure detection is to detect a block error rate (BLER) on a beam. When a BLER on a beam is greater than the threshold, the beam is considered to be faulty at this time.

6. Hybrid Automatic Repeat Request (HARQ)

In a wireless transmission environment, channel transmission quality is poor due to fading caused by channel noise and mobility and interference from other users. Therefore, a data packet needs to be protected from various types of interference. The protection is to use a forward error correction code to transmit an additional bit in the packet. However, excessive forward error correction codes lead to low transmission efficiency. The HARQ can efficiently compensate for a bit error caused by link adaptation, to increase a data transmission rate, and reduce a data transmission delay. A HARQ mechanism is used to save received data and request a sender to retransmit the data when a receiver fails to decode the data. The receiver combines the retransmitted data with the previously received data and then decodes the data. Therefore, a quantity of retransmissions is reduced, and a delay is further reduced.

The foregoing briefly describes some terms (nouns) in the communication method provided in the embodiments. The following describes a system architecture of the communication method provided in the embodiments.

The communication method provided in the embodiments may be applied to a mobile communication system operating in an unlicensed spectrum, for example, a long term evolution (LTE) technology, 4.5G, a 5^{th} generation (5G) mobile communication system, or a future mobile communication system. The unlicensed spectrum may include a 2.4 GHz or 5 GHz frequency band. For ease of understanding, a system architecture of the mobile communication system is first briefly described in the embodiments.

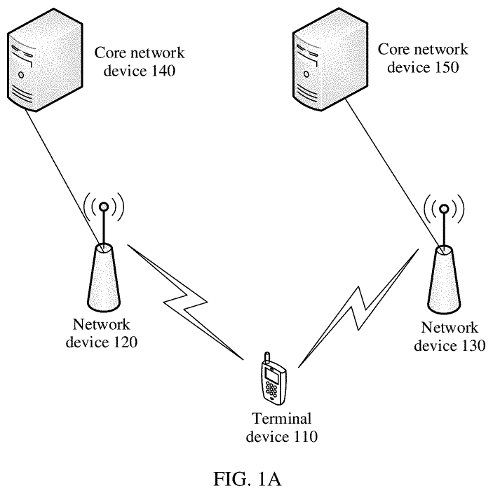

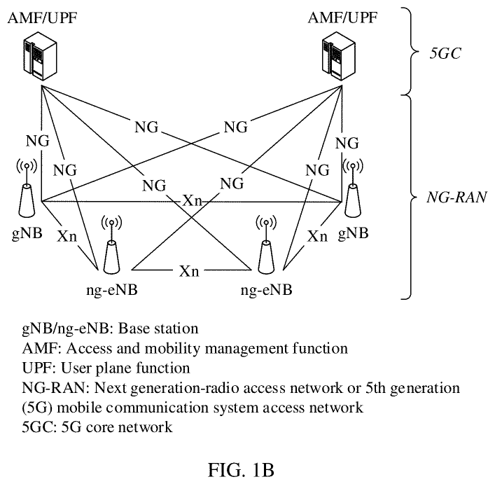

FIG. 1A is a schematic diagram of a system architecture of a mobile communication system according to an embodiment. As shown in FIG. 1A, the mobile communication system may include at least one terminal device (a terminal device 110 in FIG. 1A) and at least one network device (a network device 120 and a network device 130 in FIG. 1A). Optionally, the mobile communication system may further include at least one core network device, for example, a core network device 140 and a core network device 150 in FIG. 1A. The terminal device 110 may be connected to the network device 120 and/or the network device 130 in a wireless manner. The terminal device may be located at a fixed position or may be mobile. The network device 120 may access the core network device 140, and the network device 130 may access the core network device 150. Optionally, the network device 120 and the network device 130 may jointly access one core network device. FIG. 1A is merely a schematic diagram. The mobile communication system may further include another network device, for example, may further include a wireless relay device and/or a wireless backhaul device, which are/is not shown in FIG. 1A. Quantities of terminal devices, network devices, and/or core network devices included in the mobile communication system are not limited in this embodiment.

The terminal device 110 may be an entity, for example, a mobile phone UE, that is configured to receive or transmit a signal on a user side. The terminal device may also be referred to as a terminal, UE, a mobile station (MS), a mobile terminal (MT), or the like. The terminal device may be a mobile phone, a tablet (Pad), a computer with a wireless transceiver function, or the like. A technology and a device form that are used by the terminal device are not limited in the embodiments.

The network device may be an entity, for example, a gNB, that is configured to transmit or receive a signal on a network side. The network device may alternatively be an access device that connects the terminal device to the mobile communication system in a wireless manner. For example, the network device may be a NodeB, an evolved NodeB (eNB), a transmission reception point (TRP), a next generation NodeB (gNB) in a 5G mobile communication system, or a base station in a future mobile communication system. A technology and a device form that are used by the network device are not limited in the embodiments.

In some feasible implementations, the network device 120 and the network device 130 may be network devices of different operators and may work on a same unlicensed frequency band. At a same moment, the terminal device 110 may communicate with one network device (the network device 120 or the network device 130).

The core network device may be a 4G core network device or may be a 5G core network device.

In some feasible implementations, the terminal device and the network device in the mobile communication system may be deployed on land, and include indoor, outdoor, handheld, or vehicle-mounted devices.

When both the core network device 140 and the core network device 150 in FIG. 1A are 5G core network devices, FIG. 1B is a schematic diagram of a 5G network architecture according to an embodiment. As shown in FIG. 1B, the 5G network architecture includes a 5G access network (namely, a next generation-radio access network (NG-RAN)) and a 5G core (5G core, 5GC) network. The 5G access network includes two types of nodes: a gNB and a ng-eNB. The gNB is a node that provides user-plane and control-plane protocol terminals of a new radio (NR) for the UE. The ng-eNB is a node that provides user-plane and control-plane protocol terminals of evolved universal terrestrial radio access (E-UTRA) for the UE. Connection may be established between the gNB and the gNB, the gNB and the ng-eNB, or the ng-eNB and ng-eNB through an Xn interface. The Xn interface is a network interface between NG-RAN nodes. Connections may be established between the gNB and the 5GC (core network), and the ng-eNB and the 5GC (core network) through NG interfaces. The gNB may be connected to an access and mobility management function (AMF) through an NG-C interface and may be connected to a user plane function (UPF) through an NR-U interface. The NG-C interface is a control-plane interface between the NG-RAN and the 5GC, and the NG-U interface is a user-plane interface between the NG-RAN and the 5GC.

The foregoing content describes a system architecture of the communication method provided in the embodiments. The following describes in detail the communication method provided in the embodiments .

A basis of wireless communication is spectrum resources. The spectrum resources may be classified into two types: a licensed spectrum and an unlicensed spectrum. The licensed spectrum can be used only by a corresponding operator in a place, and the unlicensed spectrum can be used by any operator and is a shared spectrum resource. In the unlicensed spectrum, a plurality of devices (such as base stations, terminals, or wireless network accessing devices) may share a same unlicensed spectrum based on an LBT channel contention access mechanism.

For example, a device 1, a device 2, and a device 3 share a same unlicensed frequency band (for example, 5.925 GHz to 6.425 GHz). It is assumed that both the device 1 and the device 2 want to send data to the device 3. To reduce data transmission collisions and data sending retries, both the device 1 and the device 2 need to perform LBT before sending the data, to monitor whether a channel is idle. If the device 1 detects that the channel is idle, the device 1 may obtain a channel occupancy time. To ensure a data sending success rate of the device 1, the device 1 may notify other devices (for example, the device 2 and the device 3) of the channel occupancy time of the preempted channel, so that the device 2 and the device 3 know that the channel occupancy time belongs to the device 1, and do not send data within the channel occupancy time.

A frequency band used in 5G is high, and a path loss at a high frequency is large. Directional transmission (namely, beam-based transmission) is used to compensate for the path loss. Different directions (or beams) are independent of each other, and basically have no interference. Therefore, in the 5G, LBT of a device working on the unlicensed frequency band may be direction-based (or beam-based). However, the channel occupancy time notified by the device 1 to the other devices is applicable only to omnidirectional-based LBT and is not applicable to direction-based (or beam-based) LBT. In other words, the device 1 does not notify the other devices of direction information of the channel occupancy time.

Therefore, the embodiments may provide a communication method. In the communication method, direction-based channel occupancy indication information is provided. When the indication information indicates that a channel on a beam is occupied, downlink measurement is not performed, and when the indication information indicates that a channel on a beam is not occupied, downlink measurement is performed on the beam. Therefore, downlink measurement efficiency and accuracy of a downlink measurement result can be improved.

It may be understood that all devices (including the terminal device and the network device) in the embodiments may work in the unlicensed spectrum and need to perform direction-based LBT before sending data. The terminal device in the embodiments may be the terminal device 110 in FIG. 1A. The network device may be the network device 120 or the network device 130 in FIG. 1A, or the network device may be any gNB or ng-eNB in FIG. 1B. This is not limited in the embodiments.

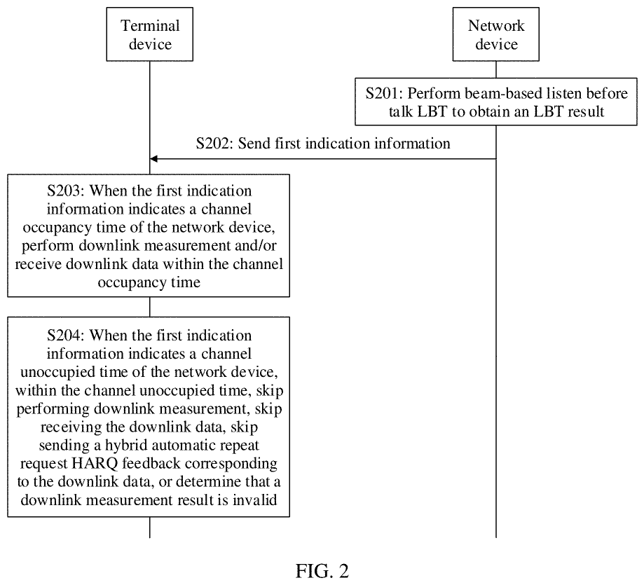

FIG. 2 is a schematic flowchart of a communication method according to an embodiment. As shown in FIG. 2, the communication method provided in this embodiment includes, but is not limited to, the following steps.

S201: A network device performs beam-based listen before talk (LBT) to obtain an LBT result.

In some feasible implementations, the network device may receive a signal of each channel on each beam (or in each direction) and may perform signal strength measurement on the signal of the channel on the beam (or in the direction). The network device may obtain a preset signal strength threshold. If a measured signal strength of a channel on a beam (or in a direction) is greater than the signal strength threshold, it indicates that data transmission is not performed on the channel on the beam (or in the direction) at this time. In this case, the network device determines that the channel is idle on the beam (or in the direction) and determines a channel occupancy time of the network device on the beam (or in the direction) of the channel If a measured signal strength of a channel on a beam (or in a direction) is less than or equal to the signal strength threshold, it indicates that data transmission is performed on the channel on the beam (or in the direction) at this time. In this case, the network device determines that the channel is busy on the beam (or in the direction), and determines a backoff time (namely, a channel unoccupied time) of the network device on the beam (or in the direction) of the channel The backoff time (namely, the channel unoccupied time) may be a preset time. For example, the backoff time or the channel unoccupied time is 5 ms (milliseconds). The channel occupancy time may be determined based on a size of to-be-transmitted data. After performing LBT on each beam (or direction) of each channel, the network device obtains an LBT result (whether the channel is idle or busy, a channel occupancy time, or a channel unoccupied time) of the beam of the channel.

For example, it is assumed that the network device needs to monitor two channels: a channel 1 and a channel 2. The channel 1 has four beams in different directions: a beam 1, a beam 2, a beam 3, and a beam 4. The channel 2 also has four beams in different directions: a beam 5, a beam 6, a beam 7, and a beam 8. For the channel 1, the network device may separately receive signals on the beam 1, the beam 2, the beam 3, and the beam 4, and separately perform signal strength measurement on the signals on the beam 1, the beam 2, the beam 3, and the beam 4. If measured signal strengths on the beam 1 and the beam 2 each are greater than the signal strength threshold, the network device determines that the channel 1 is idle on the beam 1 and the beam 2, and determines channel occupancy times of the network device on the beam 1 and the beam 2 of the channel 1 based on the size of the to-be-transmitted data. If measured signal strengths on the beam 3 and the beam 4 each are less than or equal to the signal strength threshold, the network device determines that the channel 1 is busy on the beam 3 and the beam 4, and obtains preset channel unoccupied times (namely, backoff times) of the channel 1 on the beam 3 and the beam 4. Similarly, for the channel 2, the network device may separately receive signals on the beam 5, the beam 6, the beam 7, and the beam 8, and separately perform signal strength measurement on the signals on the beam 5, the beam 6, the beam 7, and the beam 8. If a measured signal strength on the beam 7 is greater than the signal strength threshold, the network device determines that the channel 1 is idle on the beam 7 and determines a channel occupancy time of the network device on the beam 7 of the channel 2 based on the size of the to-be-transmitted data. If measured signal strengths on the beam 5, the beam 6, and the beam 8 each are less than or equal to the signal strength threshold, the network device determines that the channel 2 is busy on the beam 5, the beam 6, and the beam 8, and obtains preset channel unoccupied times (namely, backoff times) of the channel 2 on the beam 5, the beam 6, and the beam 8. In conclusion, the LBT result, of each beam of each channel, obtained by the network device by performing LBT may be that the channel 1 is idle on the beam 1 and the beam 2 and include the channel occupancy times; that the channel 1 is busy on the beam 3 and the beam 4 and include the channel unoccupied times; that the channel 2 is idle on the beam 7 and include the channel occupancy time; and that the channel 2 is busy on the beam 5, the beam 6, and the beam 8 and include the channel unoccupied times.

Optionally, preset channel unoccupied times (namely, backoff times) on different beams may be the same or may be different. For example, the preset channel unoccupied time of the channel 2 on the beam 5 is 5 ms, the preset channel unoccupied time of the channel 2 on the beam 6 is 7 ms, and the preset channel unoccupied time of the channel 2 on the beam 8 is 4 ms.

S202: The network device sends first indication information to a terminal device. Correspondingly, the terminal device receives the first indication information.

In some feasible implementations, the first indication information may indicate channel occupancy information of the network device. The channel occupancy information may be used to represent a channel occupancy status obtained after the network device performs beam-based LBT. For example, the channel occupancy information may include a channel occupancy time of the channel on a beam, and/or a channel unoccupied time of the channel on a beam. The first indication information may include at least one beam identity and channel occupancy information corresponding to each of the at least one beam identity. The beam identity included in the first indication information may be used to notify the terminal device of a beam corresponding to the channel occupancy information of the network device. The channel occupancy information corresponding to the beam identity included in the first indication information may be used to notify the terminal device of an LBT result of the network device. The channel occupancy information may include the channel occupancy time and/or the channel unoccupied time. The channel occupancy time may include a channel occupancy start time and channel occupancy duration. The channel unoccupied time may include unoccupied duration of the channel.

Optionally, the first indication information may further include an identifier of a transmission reception point (TRP) to which each beam identified by the at least one beam identity belongs and/or an identifier of a serving cell covered by the beam. The identifier of the TRP included in the first indication information is used to notify the terminal device of a TRP corresponding to the channel occupancy information of the network device. The identifier of the serving cell included in the first indication information is used to notify the terminal device of a cell corresponding to the channel occupancy information of the network device. One cell may be covered by a plurality of beams in different directions. One cell may include a plurality of TRPs and one TRP may have a plurality of beams. The first indication information in this embodiment not only includes the beam identity and the channel occupancy information but may also include the identifier of the TRP and/or the identifier of the serving cell, so that the terminal device can more accurately locate a beam on a TRP and/or a beam in a serving cell occupied or not occupied by the channel When the beam identity is multiplexed, a beam occupied by the channel or a beam not occupied by the channel can also be accurately located, thereby improving accuracy of subsequent downlink measurement, and ensuring subsequent reception of downlink data.

In some feasible implementations, after obtaining the LBT result, the network device may send the first indication information in a broadcast manner. Correspondingly, the terminal device may receive the first indication information. Optionally, the network device may alternatively send the first indication information to the terminal device in a unicast manner. Correspondingly, the terminal device may receive the first indication information. If the network device sends the first indication information in the broadcast manner, the first indication information may be carried on a group common physical downlink control channel (GC-PDCCH) for sending. If the network device sends the first indication information in the unicast manner, the first indication information may be a dedicated PDCCH. The first indication information may indicate the channel occupancy information of the network device. The channel occupancy information may include the channel occupancy time and/or the channel unoccupied time. It may be understood that when the network device sends the first indication information to the terminal device in the unicast manner, the first indication information is sent by using an idle beam in the LBT result.

In some feasible implementations, because one gNB may manage a plurality of cells, and a coverage area of each cell may be provided by a plurality of TRPs, the network device may send the first indication information to the terminal device by using the TRPs. The network device may send the first indication information to a TRP in the cell managed by the network device. After receiving the first indication information, the TRP may forward the first indication information to the terminal device. The first indication information may indicate the channel occupancy information of the network device. The channel occupancy information may include the channel occupancy time or the channel unoccupied time.

S203: When the first indication information indicates the channel occupancy time of the network device, the terminal device performs downlink measurement and/or receives the downlink data within the channel occupancy time.

In some feasible implementations, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

In some feasible implementations, after receiving the first indication information, the terminal device may parse the first indication information. When the first indication information indicates the channel occupancy time of the network device, if parsing that the first indication information includes the at least one beam identity and a channel occupancy time corresponding to each of the at least one beam identity, the terminal device may detect whether there is a downlink resource configured by the network device for the terminal device. If there is the downlink resource configured by the network device for the terminal device, the terminal device may detect whether there is a beam identity of a first beam in the at least one beam identity. The first beam may be a downlink transmit beam in the downlink resource configured by the network device for the terminal device. If there is the beam identity of the first beam in the at least one beam identity, it indicates that the first beam preempted by the network device is preempted by the terminal device. In this case, the terminal device performs downlink measurement on the first beam, and/or receives downlink semi-persistent scheduling (DL SPS) from the first beam within a channel occupancy time of the first beam. After an SPS resource is activated, the terminal device may receive and send data by using the activated SPS resource. Therefore, the terminal device receives the DL SPS from the first beam, in other words, receives the downlink data from the first beam. The channel occupancy time may include the channel occupancy start time and the channel occupancy duration. Optionally, if there is no downlink resource configured by the network device for the terminal device, the terminal device skips performing downlink measurement and/or skips receiving the downlink data.

In this embodiment, when the first indication information includes the channel occupancy time of the first beam, and the network device configures the corresponding downlink resource for the terminal device (where the first beam is the downlink transmit beam in the downlink resource configured by the network device for the terminal device), the terminal device performs downlink measurement on the first beam, and/or receives the downlink data from the first beam within the channel occupancy time of the first beam. Therefore, unnecessary measurement can be reduced, and measurement efficiency and accuracy of a measurement result can be improved.

It may be understood that, that the terminal device performs downlink measurement on the first beam within a channel occupancy time of the first beam may include: The network device sends a downlink reference signal or a PDCCH to the terminal device within the channel occupancy time of the first beam by using the first beam. The terminal device receives the downlink reference signal on the first beam, and performs CSI measurement, beam RSRP measurement, or beam failure detection on the first beam within the channel occupancy time of the first beam based on the downlink reference signal on the first beam. Alternatively, the terminal device receives the PDCCH on the first beam and performs PDCCH detection on the first beam within the channel occupancy time of the first beam.

It may be further understood that before the terminal device receives the downlink data from the first beam, the network device sends the downlink data to the terminal device within the channel occupancy time of the first beam by using the first beam.

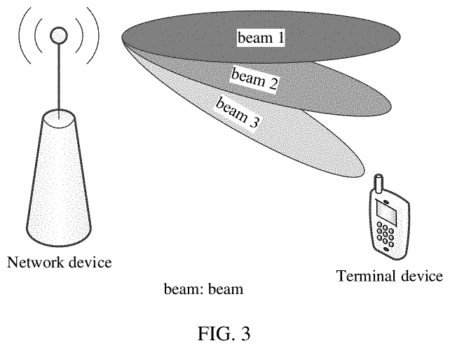

For example, FIG. 3 is a schematic diagram of an idle beam on a network side according to an embodiment. As shown in FIG. 3, a beam 1, a beam 2, and a beam 3 on the network side are all idle. In this case, the first indication information includes three beam identities: the beam 1, the beam 2, and the beam 3, and channel occupancy times respectively corresponding to the three beam identities (it is assumed that the channel occupancy times corresponding to the identities are the same). For example, the channel occupancy time is a channel occupancy start time 1 ms, and channel occupancy duration 5 ms. It is assumed that the downlink transmit beam in the downlink resource configured by the network device for the terminal device is the beam 3 (in other words, the first beam is the beam 3). Because it is parsed that the first indication information includes the beam identities: the beam 1, the beam 2, and the beam 3, and the channel occupancy times respectively corresponding to the beam 1, beam 2, and beam 3, the terminal device detects whether there is the downlink resource configured by the network device for the terminal device. When detecting that there is the downlink resource configured by the network device for the terminal device, the terminal device detects whether the beam identity included in the first indication information includes the downlink transmit beam: the beam 3 included in the downlink resource. Because the first indication information includes the beam 3, it indicates that the beam 3 preempted by the network device is preempted for the terminal device. Therefore, the terminal device performs downlink measurement on the beam 3, and/or receives the downlink data from the beam 3 within the channel occupancy time (the 1^{st} ms to the 6^{th} ms) of the beam 3.

S204: When the first indication information indicates the channel unoccupied time of the network device, within the channel unoccupied time, the terminal device skips performing downlink measurement, skips receiving the downlink data, skips sending a hybrid automatic repeat request HARQ feedback corresponding to the downlink data, or determines that a downlink measurement result is invalid.

In some feasible implementations, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

In some feasible implementations, when the first indication information indicates the channel unoccupied time of the network device, if parsing that the first indication information includes one or more beam identities and a channel unoccupied time corresponding to the one or more beam identities, the terminal device may detect whether there is the downlink resource configured by the network device for the terminal device. If there is the downlink resource configured by the network device for the terminal device, and the one or more beam identities include the beam identity of the first beam included in the downlink resource, it indicates that the network device does not preempt the first beam for the terminal device. In this case, within a channel unoccupied time of the first beam, the terminal device skips performing downlink measurement on the first beam, skips receiving the DL SPS from the first beam, skips sending a HARQ feedback corresponding to the DL SPS, or determines that a downlink measurement result of the first beam is invalid. After the SPS resource is activated, the terminal device may receive and send data by using the activated SPS resource. Therefore, the terminal device skips receiving the DL SPS from the first beam, in other words, skips receiving the downlink data from the first beam; and skips sending the HARQ feedback corresponding to the DL SPS, in other words, skips sending the HARQ feedback corresponding to the downlink data. The first beam may be the downlink transmit beam in the downlink resource configured by the network device for the terminal device. The channel unoccupied time may include the unoccupied duration of the channel.

Optionally, if there is no downlink resource configured by the network device for the terminal device, the terminal device skips performing downlink measurement, skips receiving the downlink data, skips sending the HARQ feedback corresponding to the downlink data, or determines that the downlink measurement result is invalid.

In this embodiment, when the first indication information includes the channel unoccupied time of the first beam, even if the network device configures the corresponding downlink resource for the terminal device (where the first beam is the downlink transmit beam in the downlink resource configured by the network device for the terminal device), within the channel unoccupied time of the first beam, the terminal device skips performing downlink measurement on the first beam, skips receiving the downlink data from the first beam, skips sending the HARQ feedback corresponding to the downlink data, or determines that the downlink measurement result of the first beam is invalid. This may exclude a downlink measurement failure caused because the network side does not preempt the channel, further reduce unnecessary measurement, and improve accuracy of a measurement result.

It may be understood that, that within a channel unoccupied time of the first beam, the terminal device skips performing downlink measurement on the first beam, skips receiving the DL SPS from the first beam, and skips sending a HARQ feedback corresponding to the DL SPS may include: When not preempting the first beam, the network device does not send the downlink reference signal, the PDCCH, or the downlink data within the channel unoccupied time of the first beam by using the first beam. Because the network device skips sending the downlink data on the first beam, the terminal device cannot receive the downlink data on the first beam. According to a HARQ mechanism, the terminal device requests the network device to perform retransmission. Therefore, the terminal device skips sending the HARQ feedback within the channel unoccupied time of the first beam, to reduce signaling overheads.

It may be further understood that when not preempting the downlink transmit beam in the downlink resource configured for the terminal device, the network device cannot send the reference signal, the PDCCH, the downlink data, or the like by using the downlink transmit beam configured for the terminal device. Therefore, a result of CSI measurement, beam RSRP measurement, beam failure detection, or PDCCH detection performed by the terminal device on the first beam within the channel unoccupied time of the first beam is a failure. The failure is caused because the network device does not preempt the downlink transmit beam configured for the terminal device. Therefore, a result of downlink measurement caused by the failure is invalid and does not comply with an actual situation.

For example, it is assumed that the first indication information includes two beam identities: a beam 5 and a beam 8, a channel unoccupied time (for example, 4 ms) corresponding to the beam 5, and a channel unoccupied time (for example, 6 ms) corresponding to the beam 8. It is assumed that the downlink transmit beam in the downlink resource configured by the network device for the terminal device is the beam 8 (in other words, the first beam is the beam 8). Because the network device configures the downlink resource for the terminal device, and the beam identity included in the first indication information includes the downlink transmit beam: the beam 8 included in the downlink resource, it indicates that the network device does not preempt the beam 8 for the terminal device at this time. Therefore, within the channel unoccupied time (such as 6 ms starting from a current time) of the beam 8, the terminal device skips performing downlink measurement on the beam 8, skips receiving the downlink data from the beam 8, skips sending the HARQ feedback corresponding to the downlink data, or determines that a downlink measurement result of the beam 8 is invalid.

In an optional embodiment, the first indication information may include N beam identities, channel occupancy times respectively corresponding to K beam identities in the N beam identities, and channel unoccupied times respectively corresponding to N—K beam identities in the N beam identities. Therefore, when the first indication information indicates both the channel occupancy time and the channel unoccupied time, the terminal device may detect whether there is the downlink resource configured by the network device for the terminal device. If there is the downlink resource configured by the network device for the terminal device, the terminal device may determine, based on the first indication information, channel occupancy information corresponding to the downlink transmit beam (namely, the first beam) included in the downlink resource. If determining that the channel occupancy information corresponding to the first beam is the channel occupancy time, the terminal device may perform downlink measurement on the first beam, and/or receive the downlink data from the first beam within the channel occupancy time of the first beam. If determining that the channel occupancy information corresponding to the first beam is the channel unoccupied time, within the channel unoccupied time of the first beam, the terminal device may skip performing downlink measurement on the first beam, skip receiving the downlink data from the first beam, skip sending the HARQ feedback corresponding to the downlink data, or determine that the downlink measurement result of the first beam is invalid. N is an integer greater than or equal to 2, and K is an integer greater than or equal to 1.

For example, it is assumed that the first indication information includes eight beam identities: a beam 1, a beam 2, a beam 3, a beam 4, a beam 5, a beam 6, a beam 7, and a beam 8, channel occupancy times respectively corresponding to three of the eight beam identities: the beam 1, the beam 2, and the beam 7, and channel unoccupied times respectively corresponding to five of the eight beam identities: the beam 3, the beam 4, the beam 5, the beam 6, and the beam 8. It is assumed that the downlink transmit beam (namely, the first beam) included in the downlink resource configured by the network device for the terminal device is the beam 6. Because the network device configures the downlink resource for the terminal device, the terminal device may determine, based on the first indication information, channel occupancy information corresponding to the downlink transmit beam: the beam 6 included in the downlink resource. Because the channel occupancy information corresponding to the beam 6 in the first indication information is the channel unoccupied time, within the channel unoccupied time of the beam 6, the terminal device may skip performing downlink measurement on the beam 6, skip receiving the downlink data from the beam 6, skip sending the HARQ feedback corresponding to the downlink data, or determine that a downlink measurement result of the beam 6 is invalid. Similarly, it is assumed that the downlink transmit beam (namely, the first beam) included in the downlink resource configured by the network device for the terminal device is the beam 7. Because channel occupancy information corresponding to the beam 7 in the first indication information is the channel occupancy time, the terminal device may perform downlink measurement on the beam 7, and/or receive the downlink data from the beam 7 within the channel occupancy time of the beam 7.

In this embodiment, the network device performs beam-based LBT to obtain the LBT result and sends the first indication information to the terminal device. When the first indication information indicates the channel occupancy time of the network device, if parsing that the first indication information includes the at least one beam identity and the channel occupancy time corresponding to each of the at least one beam identity, and the beam identity included in the first indication information includes the downlink transmit beam (namely, the first beam) included in the downlink resource configured by the network device for the terminal device, the terminal device performs downlink measurement on the first beam, and/or receives the downlink data from the first beam within the channel occupancy time of the first beam. When the first indication information indicates the channel occupancy time of the network device, if parsing that the first indication information includes one or more beam identities and channel unoccupied time corresponding to the one or more beam identities, and the beam identity included in the first indication information includes the downlink transmit beam (namely, the first beam) included in the downlink resource configured by the network device for the terminal device, within the channel unoccupied time of the first beam, the terminal device skips performing downlink measurement on the first beam, skips receiving the downlink data from the first beam, skips sending the HARQ feedback corresponding to the downlink data, or determines that the downlink measurement result of the first beam is invalid. In this embodiment, only when the network side preempts the downlink transmit beam included in the downlink resource configured for the terminal device, the terminal device performs downlink measurement on the downlink transmit beam and/or receives the downlink data from the downlink transmit beam. When the network side does not preempt the downlink transmit beam included in the downlink resource configured for the terminal device, the terminal device skips performing downlink measurement on the downlink transmit beam, skips receiving the downlink data from the downlink transmit beam, or the like. Therefore, not only direction-based channel occupancy indication information is provided, but also unnecessary measurement is reduced, a downlink measurement failure caused because the network side does not preempt the channel is excluded, and measurement efficiency and accuracy of a measurement result are improved.

In another optional embodiment, in the communication method provided in this embodiment, omnidirectional-based channel occupancy indication information may be further provided. When the indication information indicates that the channel is occupied, downlink measurement is not performed, and when the indication information indicates that the channel is not occupied, downlink measurement is performed. Therefore, unnecessary downlink measurement can be reduced and power consumption of the terminal device can be reduced.

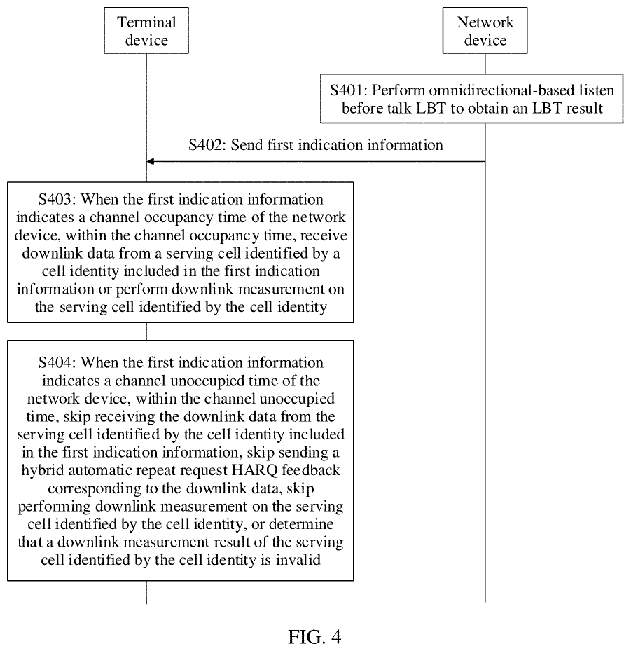

FIG. 4 is another schematic flowchart of a communication method according to an embodiment. As shown in FIG. 4, the communication method provided in this embodiment includes, but is not limited to, the following steps.

S401: A network device performs omnidirectional-based listen before talk (LBT) to obtain an LBT result.

In some feasible implementations, the network device may receive signals of each channel in all directions and may perform signal strength measurement on the signals of the channel in all directions. The network device may obtain a preset signal strength threshold. If a measured signal strength on a channel is greater than the signal strength threshold, it indicates that data transmission is not performed on the channel at this time. In this case, the network device determines that the channel is idle, and determines a channel occupancy time of the network device on the channel. If a measured signal strength on a channel is less than or equal to the signal strength threshold, it indicates that data transmission is performed on the channel at this time. In this case, the network device determines that the channel is busy, and determines a backoff time (namely, a channel unoccupied time) of the network device on the channel. The backoff time (namely, the channel unoccupied time) may be a preset time. For example, the backoff time or the channel unoccupied time is 5 ms (milliseconds). The channel occupancy time may be determined based on a size of to-be-transmitted data. After performing omnidirectional-based LBT on each channel, the network device obtains an LBT result (whether the channel is idle or busy, a channel occupancy time, or a channel unoccupied time) of the channel.

For example, it is assumed that the network device needs to monitor four channels: a channel 1, a channel 2, a channel 3, and a channel 4. The network device may separately receive signals of the channel 1, the channel 2, the channel 3, and the channel 4 in all directions, and may perform signal strength measurement on the signals of the channels in all directions. If a measured signal strength on the channel 3 is greater than the signal strength threshold, the network device determines that the channel 3 is idle and determines a channel occupancy time of the network device on the channel 3 based on the size of the to-be-transmitted data. If measured signal strengths on the channel 1, the channel 2, and the channel 3 each are less than or equal to the signal strength threshold, the network device determines that the channel 1, the channel 2, and the channel 3 are all busy, and obtains preset channel unoccupied times (namely, backoff times) on the channel 1, the channel 2, and the channel 3.

Optionally, preset channel unoccupied times (namely, backoff times) on different channels may be the same or may be different. For example, the preset channel unoccupied time on the channel 1 is 3 ms, and the preset channel unoccupied time on the channel 2 is 10 ms.

S402: The network device sends first indication information to a terminal device. Correspondingly, the terminal device receives the first indication information.

In some feasible implementations, the first indication information may indicate channel occupancy information of the network device. The channel occupancy information may be used to represent a channel occupancy status obtained after the network device performs omnidirectional-based LBT. The first indication information may include a cell identity and the channel occupancy information. The channel occupancy information includes the channel occupancy time or the channel unoccupied time. The channel occupancy time may include a channel occupancy start time and channel occupancy duration. The channel unoccupied time may include unoccupied duration of the channel.

In some feasible implementations, after obtaining the LBT result, the network device may determine a cell to which an idle channel in the LBT result belongs and a cell to which a non-idle channel (namely, a busy channel) in the LBT result belongs. For example, the channel 3 is idle, and the network device determines a cell to which the channel 3 belongs. The channel 1, the channel 2, and the channel 4 are busy, and the network device determines cells to which the channel 1, the channel 2, and the channel 4 respectively belong. After determining the cell corresponding to the idle channel and/or the cell corresponding to the non-idle channel (namely, the busy channel) in the LBT result, the network device may send the first indication information to the terminal device in a broadcast manner. Correspondingly, the terminal device may receive the first indication information. Optionally, the network device may alternatively send the first indication information to the terminal device in a unicast manner. Correspondingly, the terminal device may receive the first indication information. If the network device sends the first indication information in the broadcast manner, the first indication information may be carried on a GC-PDCCH for sending. If the network device sends the first indication information in the unicast manner, the first indication information may be a dedicated PDCCH. The first indication information may indicate the channel occupancy time and/or the channel unoccupied time of the network device. It may be understood that when the network device sends the first indication information to the terminal device in the unicast manner, the first indication information is sent on the idle channel included in the LBT result.

In some feasible implementations, because one gNB may manage a plurality of cells, and a coverage area of each cell may be provided by a plurality of TRPs, the network device may send the first indication information to the terminal device by using the TRPs. The network device may send the first indication information to a TRP in the cell managed by the network device. After receiving the first indication information, the TRP may forward the first indication information to the terminal device. The first indication information may indicate the channel occupancy time or the channel unoccupied time of the network device.

S403: When the first indication information indicates the channel occupancy time of the network device, within the channel occupancy time, the terminal device receives downlink data from a serving cell identified by the cell identity included in the first indication information or performs downlink measurement on the serving cell identified by the cell identity.

In some feasible implementations, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

In some feasible implementations, after receiving the first indication information, the terminal device may parse the first indication information. When the first indication information indicates the channel occupancy time of the network device, if parsing that the first indication information includes the cell identity and the channel occupancy time, the terminal device may detect whether there is a downlink resource configured by the network device for the terminal device. For ease of description, the following uses an example in which the first indication information includes one cell identity and one channel occupancy time for descriptions. If there is the downlink resource configured by the network device for the terminal device, the terminal device may detect whether the cell identity included in the first indication information is an identifier of a serving cell of the terminal device included in the downlink resource. If the cell identity included in the first indication information is the identifier of the serving cell of the terminal device included in the downlink resource, within the channel occupancy time, the terminal device receives DL SPS from the serving cell identified by the cell identity or performs downlink measurement on the serving cell identified by the cell identity. After an SPS resource is activated, the terminal device may receive and send data by using the activated SPS resource. Therefore, the terminal device receives the DL SPS from the serving cell identified by the cell identity, in other words, receives the downlink data from the serving cell identified by the cell identity. The channel occupancy time may include the channel occupancy start time and the channel occupancy duration.

Optionally, if there is no downlink resource configured by the network device for the terminal device, the terminal device skips performing downlink measurement and/or skips receiving the downlink data.

Optionally, if the cell identity included in the first indication information is not the identifier of the serving cell of the terminal device included in the downlink resource, the terminal device skips receiving the downlink data from the serving cell identified by the cell identity, or skips performing downlink measurement on the serving cell identified by the cell identity.

S404: When the first indication information indicates the channel unoccupied time of the network device, within the channel unoccupied time, the terminal device skips receiving the downlink data from the serving cell identified by the cell identity included in the first indication information, skips sending a HARQ feedback corresponding to the downlink data, skips performing downlink measurement on the serving cell identified by the cell identity, or determines that a downlink measurement result of the serving cell identified by the cell identity is invalid.

In some feasible implementations, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

In some feasible implementations, when the first indication information indicates the channel unoccupied time of the network device, if parsing that the first indication information includes the cell identity and the channel unoccupied time, the terminal device may detect whether there is the downlink resource configured by the network device for the terminal device. For ease of description, the following uses an example in which the first indication information includes one cell identity and one channel unoccupied time for descriptions. If there is the downlink resource configured by the network device for the terminal device, the terminal device may detect whether the cell identity included in the first indication information is the identifier of the serving cell of the terminal device included in the downlink resource. If the cell identity included in the first indication information is the identifier of the serving cell of the terminal device included in the downlink resource, within the channel unoccupied time, the terminal device skips receiving the DL SPS from the serving cell identified by the cell identity, skips sending a HARQ feedback corresponding to the DL SPS, skips performing downlink measurement on the serving cell identified by the cell identity, or determines that the downlink measurement result of the serving cell identified by the cell identity is invalid. After the SPS resource is activated, the terminal device may receive and send data by using the activated SPS resource. Therefore, the terminal device skips receiving the DL SPS from the serving cell identified by the cell identity, in other words, skips receiving the downlink data from the serving cell identified by the cell identity, and skips sending the HARQ feedback corresponding to the DL SPS, in other words, skips sending the HARQ feedback corresponding to the downlink data. The channel unoccupied time may include the unoccupied duration of the channel

In this embodiment, when the first indication information indicates the channel unoccupied time, even if the network device configures the corresponding downlink resource (the cell identity included in the first indication information is the identifier of the serving cell of the terminal device included in the downlink resource) for the terminal device, within the channel unoccupied time, the terminal device skips receiving the downlink data from the serving cell identified by the cell identity, skips sending the HARQ feedback corresponding to the downlink data, skips performing downlink measurement on the serving cell identified by the cell identity, or determines that the downlink measurement result of the serving cell identified by the cell identity is invalid. Therefore, unnecessary measurement can be reduced, and power consumption of the terminal device can be reduced.

It may be understood that the first indication information may include a plurality of cell identities and channel occupancy information corresponding to each of the plurality of cell identities. For example, the first indication information includes M cell identities, channel occupancy times respectively corresponding to Q cell identities in the M cell identities, and channel unoccupied times respectively corresponding to M-Q cell identities in the M cell identities.

Therefore, when the first indication information indicates both the channel occupancy time and the channel unoccupied time, the terminal device may detect whether there is the downlink resource configured by the network device for the terminal device. If there is the downlink resource configured by the network device for the terminal device, the terminal device may determine, based on the first indication information, channel occupancy information corresponding to a serving cell i of the terminal device included in the downlink resource. If determining that the channel occupancy information corresponding to the serving cell i is the channel occupancy time, the terminal device may perform downlink measurement on the serving cell i, and/or receive the downlink data from the serving cell i within the channel occupancy time. If determining that the channel occupancy information corresponding to the serving cell i is the channel unoccupied time, within the channel unoccupied time, the terminal device may skip performing downlink measurement on the serving cell i, skip receiving the downlink data from the serving cell i, skip sending the HARQ feedback corresponding to the downlink data, or determine that a downlink measurement result of the serving cell i is invalid.

For example, it is assumed that the first indication information includes three cell identities: A1, A2, and A3, a channel occupancy time corresponding to the cell identity A2 in the three cell identities, and channel unoccupied times respectively corresponding to two cell identities: A1 and A3 in the three cell identities. It is assumed that the downlink resource configured by the network device for the terminal device includes the serving cell A1 of the terminal device. Because the network device configures the downlink resource for the terminal device, the terminal device may determine, based on the first indication information, channel occupancy information corresponding to the serving cell A1 of the terminal device included in the downlink resource. Because the channel occupancy information corresponding to the serving cell A1 in the first indication information is the channel unoccupied time, within the channel unoccupied time corresponding to the cell identity A1, the terminal device may skip performing downlink measurement on the serving cell A1, skip receiving the downlink data from the serving cell A1, skip sending the HARQ feedback corresponding to the downlink data, or determine that a downlink measurement result of the serving cell A1 is invalid. Similarly, it is assumed that the downlink resource configured by the network device for the terminal device includes the serving cell A2 of the terminal device. Because the channel occupancy information corresponding to the serving cell A2 in the first indication information is the channel occupancy time, the terminal device may perform downlink measurement on the serving cell A2, and/or receive the downlink data from the serving cell A2 within the channel occupancy time corresponding to the cell identity A2.

In this embodiment, the network device performs omnidirectional-based LBT to obtain the LBT result and sends the first indication information to the terminal device. When the first indication information indicates the channel occupancy time of the network device, if the cell identity included in the first indication information is the identifier of the serving cell in the downlink resource configured by the network device for the terminal device, within the channel occupancy time included in the first indication information, the terminal device receives the downlink data from the serving cell identified by the cell identity or performs downlink measurement on the serving cell identified by the cell identity. When the first indication information indicates the channel occupancy time of the network device, if the cell identity included in the first indication information is the identifier of the serving cell in the downlink resource configured by the network device for the terminal device, within the channel unoccupied time included in the first indication information, the terminal device skips receiving the downlink data from the serving cell identified by the cell identity, skips sending the HARQ feedback corresponding to the downlink data, skips performing downlink measurement on the serving cell identified by the cell identity, or determines that the downlink measurement result of the serving cell identified by the cell identity is invalid. In this embodiment, when not preempting a channel of the serving cell included in the downlink resource configured for the terminal device, a network side skips receiving the downlink data from the serving cell, skips sending the HARQ feedback corresponding to the downlink data, skips performing downlink measurement on the serving cell, or determines that the downlink measurement result of the serving cell is invalid. Therefore, unnecessary measurement is reduced, and power consumption of the terminal device is reduced.

The communication method in the embodiments is described in detail above. To better implement the foregoing solutions, the embodiments may further provide a corresponding apparatus or device.

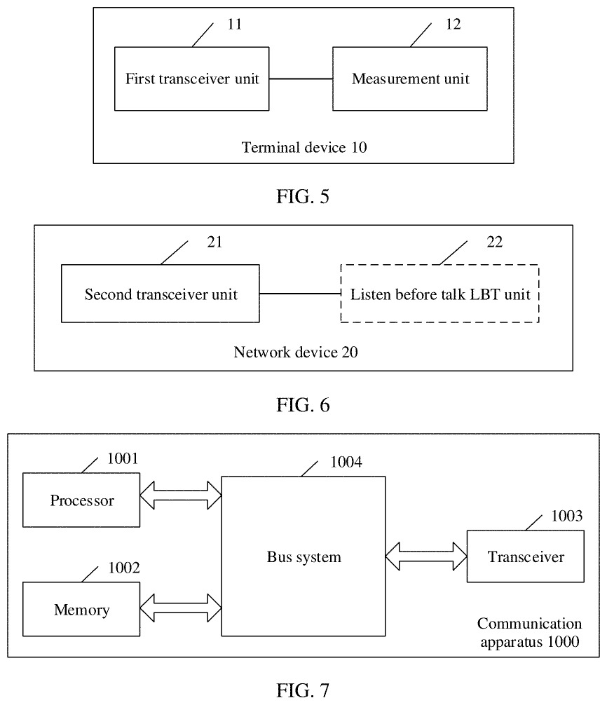

FIG. 5 is a schematic diagram of a structure of a terminal device according to an embodiment. As shown in FIG. 5, the terminal device 10 may include:

a first transceiver unit 11, configured to receive first indication information from a network device, where the first indication information indicates channel occupancy information of the network device; and a measurement unit 12, configured to: when the first indication information received by the first transceiver unit 11 indicates a channel occupancy time of the network device, perform downlink measurement within the channel occupancy time; and/or a first transceiver unit 11, further configured to: when first indication information indicates a channel occupancy time of a network device, receive downlink data within the channel occupancy time, and a measurement unit 12, further configured to: when the first indication information received by the first transceiver unit 11 indicates a channel unoccupied time of the network device, within the channel unoccupied time, skip performing downlink measurement or determine that a downlink measurement result is invalid; and/or a first transceiver unit 11, further configured to: when first indication information indicates a channel unoccupied time of a network device, skip receiving downlink data, or skip sending a HARQ feedback corresponding to the downlink data. The channel occupancy information includes the channel occupancy time or the channel unoccupied time.

In some feasible implementations, the first indication information includes at least one beam identity and channel occupancy information corresponding to each of the at least one beam identity. Alternatively, the first indication information includes a cell identity and the channel occupancy information.

In some feasible implementations, the first indication information includes the at least one beam identity and a channel occupancy time corresponding to each of the at least one beam identity. The measurement unit 12 may be configured to: when the first indication information received by the first transceiver unit 11 indicates the channel occupancy time of the network device, and when the beam identity included in the first indication information includes a beam identity of a first beam included in a downlink resource configured by the network device for the terminal device, perform downlink measurement on the first beam within a channel occupancy time of the first beam; and/or the first transceiver unit 11 may be configured to: when the first indication information indicates the channel occupancy time of the network device, and when the beam identity included in the first indication information includes the beam identity of the first beam included in the downlink resource configured by the network device for the terminal device, receive the downlink data from the first beam within the channel occupancy time of the first beam. The at least one beam identity includes the beam identity of the first beam.

In some feasible implementations, the first indication information includes the at least one beam identity and a channel unoccupied time corresponding to each of the at least one beam identity. The measurement unit 12 may be further configured to: when the first indication information received by the first transceiver unit 11 indicates the channel unoccupied time of the network device, and when the beam identity included in the first indication information includes the beam identity of the first beam included in the downlink resource configured by the network device for the terminal device, within a channel unoccupied time of the first beam, skip performing downlink measurement on the first beam, or determine that a downlink measurement result of the first beam is invalid; and/or the first transceiver unit 11 may be further configured to: when the first indication information indicates the channel unoccupied time of the network device, and when the beam identity included in the first indication information includes the beam identity of the first beam included in the downlink resource configured by the network device for the terminal device, skip receiving the downlink data from the first beam or skip sending the HARQ feedback corresponding to the downlink data within the channel unoccupied time of the first beam.

In some feasible implementations, the first indication information further includes an identifier of a TRP to which each beam identified by the at least one beam identity belongs and/or an identifier of a serving cell covered by the beam.

In some feasible implementations, the first indication information includes the cell identity and the channel occupancy time. The measurement unit 12 may be configured to: when the first indication information received by the first transceiver unit 11 indicates the channel occupancy time of the network device, and when the beam identity included in the first indication information includes the beam identity of the first beam included in the downlink resource configured by the network device for the terminal device, within the channel occupancy time, perform downlink measurement on a serving cell identified by the cell identity; and/or the first transceiver unit 11 may be configured to: when the first indication information indicates the channel occupancy time of the network device, and when the beam identity included in the first indication information includes the beam identity of the first beam included in the downlink resource configured by the network device for the terminal device, within the channel occupancy time, receive the downlink data from the serving cell identified by the cell identity.

In some feasible implementations, the first indication information includes the cell identity and the channel occupancy time. The measurement unit 12 may be further configured to: when the first indication information received by the first transceiver unit 11 indicates the channel unoccupied time of the network device, and when the beam identity included in the first indication information includes the beam identity of the first beam included in the downlink resource configured by the network device for the terminal device, within the channel unoccupied time, skip performing downlink measurement on the serving cell identified by the cell identity, or determine that a downlink measurement result of the serving cell is invalid; and/or the first transceiver unit 11 may be further configured to: when the first indication information indicates the channel unoccupied time of the network device, and when the beam identity included in the first indication information includes the beam identity of the first beam included in the downlink resource configured by the network device for the terminal device, within the channel unoccupied time, skip receiving the downlink data from the serving cell identified by the cell identity or skip sending the HARQ feedback corresponding to the downlink data.

In some feasible implementations, the first indication information is carried on a group common physical downlink control channel GC-PDCCH.

In some feasible implementations, downlink measurement includes downlink signal measurement and/or downlink channel measurement. Downlink signal measurement includes one or more of the following: channel state information CSI measurement, beam reference signal received power RSRP measurement, or beam failure detection. Downlink channel measurement includes physical downlink control channel PDCCH detection.

The measurement unit 12 may be a processing unit.

During implementation, for implementation of each module or unit, correspondingly refer to corresponding descriptions of the terminal device in the embodiment shown in FIG. 2 or FIG. 4, to perform the method and the function performed by the terminal device in the foregoing embodiment.

In this embodiment, only when a network side preempts a channel and the network side configures the corresponding downlink resource for the terminal device 10, the terminal device 10 performs downlink measurement and/or receives the downlink data within the channel occupancy time indicated by the first indication information. When the network side does not preempt the channel, even if the network side configures the corresponding downlink resource for the terminal device 10, within the channel unoccupied time indicated by the first indication information, the terminal device 10 does not need to perform downlink measurement, does not receive the downlink data, does not send the HARQ feedback corresponding to the downlink data, or determines that the downlink measurement result is invalid. Therefore, unnecessary measurement is reduced, a downlink measurement failure caused because the network side does not preempt the channel is excluded, and measurement efficiency and accuracy of a measurement result are improved.

FIG. 6 is a schematic diagram of a structure of a network device according to an embodiment. As shown in FIG. 6, the network device 20 may include:

a second transceiver unit 21, configured to send first indication information to a terminal device. The first indication information indicates channel occupancy information of the network device. The channel occupancy information includes a channel occupancy time or a channel unoccupied time. When the first indication information indicates the channel occupancy time of the network device, the first indication information indicates the terminal device to perform downlink measurement and/or receive downlink data within the channel occupancy time. When the first indication information indicates the channel unoccupied time of the network device, the first indication information indicates, within the channel unoccupied time, the terminal device to skip performing downlink measurement, skip receiving the downlink data, skip sending a HARQ feedback corresponding to the downlink data or determine that a downlink measurement result is invalid.

In some feasible implementations, the network device 20 further includes a listen before talk (LBT) unit 22. The LBT unit 22 is configured to perform beam-based LBT or is configured to perform omnidirectional-based LBT, to obtain an LBT result.

In some feasible implementations, the first indication information includes at least one beam identity and channel occupancy information corresponding to each of the at least one beam identity. Alternatively, the first indication information includes a cell identity and the channel occupancy information.

In some feasible implementations, the first indication information includes the at least one beam identity and a channel occupancy time corresponding to each of the at least one beam identity. When the first indication information indicates the channel occupancy time of the network device, the first indication information may indicate, when the beam identity included in the first indication information includes a beam identity of a first beam included in a downlink resource configured by the network device for the terminal device, the terminal device to perform downlink measurement on the first beam, and/or receive the downlink data from the first beam within a channel occupancy time of the first beam. The at least one beam identity includes the beam identity of the first beam.

In some feasible implementations, the first indication information includes the at least one beam identity and a channel unoccupied time corresponding to each of the at least one beam identity. When the first indication information indicates the channel unoccupied time of the network device, the first indication information may further indicate, when the beam identity included in the first indication information includes the beam identity of the first beam included in the downlink resource configured by the network device for the terminal device, within a channel unoccupied time of the first beam, the terminal device to skip performing downlink measurement on the first beam, skip receiving the downlink data from the first beam, skip sending the HARQ feedback corresponding to the downlink data, or determine that a downlink measurement result of the first beam is invalid.

In some feasible implementations, the first indication information may further include an identifier of a TRP to which each beam identified by the at least one beam identity belongs and/or an identifier of a serving cell covered by the beam.

In some feasible implementations, the first indication information includes the cell identity and the channel occupancy time. When the first indication information indicates the channel occupancy time of the network device, the first indication information may indicate, when the cell identity included in the first indication information is an identifier of a serving cell included in the downlink resource configured by the network device for the terminal device, within the channel occupancy time, the terminal device to receive the downlink data from the serving cell identified by the cell identity or perform downlink measurement on the serving cell.

In some feasible implementations, the first indication information includes the cell identity and the channel unoccupied time. When the first indication information indicates the channel unoccupied time of the network device, the first indication information may further indicate, when the cell identity included in the first indication information is the identifier of the serving cell included in the downlink resource configured by the network device for the terminal device, within the channel unoccupied time, the terminal device to skip receiving the downlink data from the serving cell identified by the cell identity, skip sending the HARQ feedback corresponding to the downlink data, skip performing downlink measurement on the serving cell, or determine that a downlink measurement result of the serving cell is invalid.

In some feasible implementations, the first indication information may be carried on a GC-PDCCH.

In some feasible implementations, downlink measurement may include downlink signal measurement and/or downlink channel measurement. Downlink signal measurement may include one or more of the following: CSI measurement, beam RSRP measurement, or beam failure detection. Downlink channel measurement includes PDCCH detection.

The LBT unit 22 may be a processing unit.

During implementation, for implementation of each module or unit, correspondingly, refer to corresponding descriptions of the network device in the embodiment shown in FIG. 2 or FIG. 4, to perform the method and the function performed by the network device in the foregoing embodiment.

FIG. 7 is a schematic diagram of a structure of a communication apparatus according to an embodiment. As shown in FIG. 7, the communication apparatus 1000 provided in this embodiment includes a processor 1001, a memory 1002, a transceiver 1003, and a bus system 1004. The communication apparatus 1000 provided in this embodiment may be a terminal device or a network device.

The processor 1001, the memory 1002, and the transceiver 1003 are connected by using the bus system 1004.

The memory 1002 is configured to store a program. The program may include program code and the program code may include computer operation instructions. The memory 1002 includes, but is not limited to, a random access memory (RAM), a read-only memory (ROM), an erasable programmable read-only memory (EPROM), or a compact disc read-only memory (CD-ROM). Only one memory is shown in FIG. 7. Further, a plurality of memories may be disposed as needed. The memory 1002 may alternatively be a memory in the processor 1001. This is not limited herein.

The memory 1002 stores the following elements, executable units or data structures, or subsets or extended sets thereof:

operation instructions: including various operation instructions, used for implementing various operations; and

an operating system: including various system programs, used for implementing various basic services and processing a hardware-based task.

The processor 1001 controls an operation of the communication apparatus 1000. The processor 1001 may be one or more central processing units (CPUs). When the processor 1001 is one CPU, the CPU may be a single-core CPU, or may be a multi-core CPU.

Components of the communication apparatus 1000 may be coupled together by using the bus system 1004. In addition to a data bus, the bus system 1004 may further include a power bus, a control bus, a status signal bus, and the like. However, for clear descriptions, various buses in FIG. 7 are marked as the bus system 1004. For ease of representation, only illustrative depiction is provided in FIG. 7.

Either FIG. 2 or FIG. 4 provided in the foregoing embodiments or the method of the terminal device in the foregoing embodiments; or either FIG. 2 or FIG. 4 provided in the foregoing embodiments or the method of the network device in the foregoing embodiments may be applied to the processor 1001 or may be implemented by the processor 1001. The processor 1001 may be an integrated circuit chip and has a signal processing capability. In an implementation process, each step in the foregoing method may be completed by using an integrated logic circuit of hardware in the processor 1001 or instructions in a form of software. The foregoing processor 1001 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, the steps, and logical block diagrams in the embodiments. The general-purpose processor may be a microprocessor, or the processor may be any conventional processor or the like. Steps of the methods with reference to the embodiments may be directly executed and accomplished by using a hardware decoding processor or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 1002. The processor 1001 reads information in the memory 1002, and performs, in combination with hardware of the processor 1001, the method steps of the terminal device described in either FIG. 2 or FIG. 4, or performs, in combination with hardware of the processor 1001, the method steps of the network device described in either FIG. 2 or FIG. 4.

An embodiment further provides a computer program product. The computer program product includes computer program code. When the computer program code is run on a computer, the computer is enabled to perform the method steps of the terminal device described in FIG. 2 or FIG. 4. Alternatively, when the computer program code is run on a computer, the computer is enabled to perform the method steps of the network device described in FIG. 2 or FIG. 4.

An embodiment may further provide an apparatus. The apparatus may be a chip. The chip includes a processor. The processor is configured to read and execute a computer program stored in a memory, to perform the communication method according to any one of the possible implementations of FIG. 2 or FIG. 4. Optionally, the chip further includes the memory, and the memory is connected to the processor by using a circuit or a wire. Further, optionally, the chip includes a communication interface, and the processor is connected to the communication interface. The communication interface is configured to receive data and/or information that need/needs to be processed. The processor obtains the data and/or the information from the communication interface, processes the data and/or the information, and outputs a processing result through the communication interface. The communication interface may be an input/output interface.

Optionally, the processor and the memory may be physically independent units, or the memory may be integrated with the processor.

In another embodiment, a communication system may be further provided. The communication system includes a terminal device and a network device. For example, the terminal device may be the terminal device in the embodiment shown in FIG. 2 or FIG. 4, and the network device may be the network device in the embodiment shown in FIG. 2 or FIG. 4.

A person of ordinary skill in the art may understand that all or some of the processes of the methods in embodiments may be implemented by a computer program instructing related hardware. The program may be stored in a non-transitory computer-readable storage medium. When the program runs, the processes of the methods in the embodiments are performed. The foregoing storage medium includes any medium that can store program code, such as a ROM, a random access memory RAM, a magnetic disk, or an optical disc.

The foregoing descriptions are only implementations of the embodiments , and are not intended as limiting. Any variation or replacement readily figured out by a person skilled in the art shall fall within the scope of the embodiments.

What is claimed is:

1. A communication method, comprising:
receiving, by a terminal device, first indication information from a network device, wherein the first indication information indicates channel occupancy information of the network device, and the channel occupancy information comprises a channel occupancy time or a channel unoccupied time;
when the first indication information indicates the channel occupancy time of the network device, performing, by the terminal device, downlink measurement and/or receiving downlink data within the channel occupancy time; and
when the first indication information indicates the channel unoccupied time of the network device, within the channel unoccupied time, skipping performing, by the terminal device, downlink measurement, skipping receiving the downlink data, skipping sending a hybrid automatic repeat request (HARQ) feedback corresponding to the downlink data, or determining that a downlink measurement result is invalid.

2. The communication method according to claim 1, wherein the first indication information comprises at least one beam identity and channel occupancy information corresponding to each of the at least one beam identity; or the first indication information comprises a cell identity and the channel occupancy information.

3. The communication method according to claim 2, wherein the first indication information comprises the at least one beam identity and a channel occupancy time corresponding to each of the at least one beam identity; and performing, by the terminal device, the downlink measurement and/or receiving downlink data within the channel occupancy time further comprises:
performing, by the terminal device, downlink measurement on a first beam, and/or receiving the downlink data from the first beam within a channel occupancy time of the first beam, wherein the at least one beam identity comprises a beam identity of the first beam.

4. The communication method according to claim 2, wherein the first indication information further comprises an identifier of a transmission reception point (TRP) to which each beam identified by the at least one beam identity belongs and/or an identifier of a serving cell covered by the beam.

5. The communication method according to claim 2, wherein the first indication information comprises the cell identity and the channel occupancy time; and performing, by the terminal device, the downlink measurement and/or receiving downlink data within the channel occupancy time further comprises:
within the channel occupancy time, receiving, by the terminal device, the downlink data from a serving cell identified by the cell identity and/or performing downlink measurement on the serving cell identified by the cell identity.

6. The communication method according to claim 1, wherein the first indication information is carried on a group common physical downlink control channel GC-PDCCH.

7. The communication method according to claim 1, wherein downlink measurement comprises downlink signal measurement and/or downlink channel measurement, and downlink signal measurement comprises one or more of the following: channel state information CSI measurement, beam reference signal received power RSRP measurement, or beam failure detection; and
downlink channel measurement comprises physical downlink control channel PDCCH detection.

8. A communication method, comprising:
sending, by a network device, first indication information to a terminal device, wherein the first indication information indicates channel occupancy information of the network device, and the channel occupancy information comprises a channel occupancy time or a channel unoccupied time;
when the first indication information indicates the channel occupancy time of the network device, the first indication information indicates the terminal device to perform downlink measurement and/or receive downlink data within the channel occupancy time; and when the first indication information indicates the channel unoccupied time of the network device, the first indication information indicates, within the channel unoccupied time, the terminal device to skip performing downlink measurement, skip receiving the downlink data, skip sending a HARQ feedback corresponding to the downlink data, or determine that a downlink measurement result is invalid.

9. The communication method according to claim 8, wherein the first indication information comprises at least one beam identity and channel occupancy information corresponding to each of the at least one beam identity; or the first indication information comprises a cell identity and the channel occupancy information.

10. The communication method according to claim 9, wherein the first indication information comprises the at least one beam identity and a channel occupancy time corresponding to each of the at least one beam identity; and
when the first indication information indicates the channel occupancy time of the network device, the first indication information further indicates the terminal device to perform downlink measurement on a first beam, and/or receive the downlink data from the first beam within a channel occupancy time of the first beam, wherein the at least one beam identity comprises a beam identity of the first beam.

11. The communication method according to claim 9, wherein the first indication information further comprises an identifier of a TRP to which each beam identified by the at least one beam identity belongs and/or an identifier of a serving cell covered by the beam.

12. The communication method according to claim 9, wherein the first indication information comprises the cell identity and the channel occupancy time; and
when the first indication information indicates the channel occupancy time of the network device, the first indication information further indicates, within the channel occupancy time, the terminal device to receive the downlink data from a serving cell identified by the cell identity and/or perform downlink measurement on the serving cell identified by the cell identity.

13. The communication method according to claim 8, wherein the first indication information is carried on a GC-PDCCH.

14. The communication method according to claim 8, wherein downlink measurement comprises downlink signal measurement and/or downlink channel measurement, and downlink signal measurement comprises one or more of the following: CSI measurement, beam RSRP measurement, or beam failure detection; and
downlink channel measurement comprises PDCCH detection.

15. A terminal device, comprising:
a first transceiver unit, configured to receive first indication information from a network device, wherein the first indication information indicates channel occupancy information of the network device, and the channel occupancy information comprises a channel occupancy time or a channel unoccupied time; and
a measurement unit, configured to: when the first indication information received by the first transceiver unit indicates the channel occupancy time of the network device, perform downlink measurement within the channel occupancy time; and/or a first transceiver unit, further configured to: when first indication information indicates a channel occupancy time of a network device, receive downlink data within the channel occupancy time; and
a measurement unit, further configured to: when the first indication information received by the first transceiver unit indicates a channel unoccupied time of the network device, within the channel unoccupied time, skip performing downlink measurement or determine that a downlink measurement result is invalid; and/or
a first transceiver unit, further configured to: when first indication information indicates a channel unoccupied time of a network device, skip receiving downlink data, or skip sending a HARQ feedback corresponding to the downlink data.

16. The terminal device according to claim 15, wherein the first indication information comprises at least one beam identity and channel occupancy information corresponding to each of the at least one beam identity; or the first indication information comprises a cell identity and the channel occupancy information.

17. The terminal device according to claim 16, wherein the first indication information comprises the at least one beam identity and a channel occupancy time corresponding to each of the at least one beam identity; and
the measurement unit is further configured to: when the first indication information received by the first transceiver unit indicates the channel occupancy time of the network device, perform downlink measurement on a first beam within a channel occupancy time of the first beam; and/or
the first transceiver unit is further configured to: when the first indication information indicates the channel occupancy time of the network device, receive the downlink data from the first beam within the channel occupancy time of the first beam, wherein the at least one beam identity comprises a beam identity of the first beam.

18. The terminal device according to claim 16, wherein the first indication information further comprises an identifier of a TRP to which each beam identified by the at least one beam identity belongs and/or an identifier of a serving cell covered by the beam.

19. The terminal device according to claim 16, wherein the first indication information comprises the cell identity and the channel occupancy time; and
the measurement unit is further configured to: when the first indication information received by the first transceiver unit indicates the channel occupancy time of the network device, within the channel occupancy time, perform downlink measurement on a serving cell identified by the cell identity; and/or
the first transceiver unit is further configured to: when the first indication information indicates the channel occupancy time of the network device, within the channel occupancy time, receive the downlink data from the serving cell identified by the cell identity.

20. The terminal device according to claim 15, wherein the first indication information is carried on a group common physical downlink control channel GC-PDCCH.
